(19) United States
(12) Patent Application Publication
(10) Pub. No.: US 2007/0246512 A1
(43) Pub. Date: Oct. 25, 2007

(54) USE OF TUNABLE DIODE LASERS FOR CONTROLLING A BRAZING PROCESSES

(76) Inventors: Shahabudin Kazi, Houston, TX (US); Robert T. Oesterreich, Sugar Land, TX (US)

Correspondence Address: Ms. Linda K. Russell, Air Liquide Intellectual Property Dept., 2700 Post Oak Blvd., Suite 1800, Houston, TX, 77056, US

(21) Appl. No.: 11/533,951

(22) Filed: Sep. 21, 2006

Related U.S. Application Data
(60) Provisional application No. 60/793,553, filed on Apr. 20, 2006.

(51) Int. Cl. A47J 36/02

(52) U.S. Cl. 228/101

(57) ABSTRACT

Methods and apparatus for controlling a brazing process. In one embodiment, a method includes receiving a signal from a tunable diode laser indicating a measured concentration of a gas present in an atmosphere in which the brazing process is performed. Responsive to the received signal, a control signal is issued to adjust at least one brazing process control setting affecting a change in subsequently measured concentrations of the gas present in the atmosphere.

### CROSS-REFERENCE TO RELATED APPLICATIONS

This application claims the benefit under 35 U.S.C. § 119(e) to provisional application No. 60/793,553, filed Apr. 20, 2006, the entire contents of which are incorporated herein by reference.

### BACKGROUND

During the manufacture of radiators, condensers, and other heating, ventilation, and air conditioning (HVAC) components, the components may be subjected to a manufacturing process referred to as brazing. Brazing is typically used to join two metal components together using a filler metal. During brazing, the components and the filler metal may be heated to a temperature which is greater than the melting point of the filler metal but less than the melting point of the components being joined. When the filler metal melts, the filler metal flows between the components being joined. Later, when the components and the filler metal are cooled to a temperature below the melting point of the filler metal, the filler metal solidifies and forms a connection between the components.

In some cases, to form a better connection between brazed components, a material referred to as flux may be applied to the components being brazed. During brazing, the flux may dissolve over the areas being brazed and serve to prevent oxidation or other contamination of the brazed joint, thereby improving the strength and quality of the brazed joint. Brazing may also be performed in a chamber, allowing the collection of gasses within the chamber (referred to as the atmosphere of the chamber) to be better controlled.

In some cases, to better control the atmosphere within a brazing chamber, the concentration of certain gasses within the brazing chamber may be monitored. However, the atmosphere of the brazing chamber may also include caustic chemicals, making sampling of the brazing chamber gasses difficult. Furthermore, where a gas sample is extracted, analyzing the gas sample and determining how to modify the brazing process in response to the analysis may be time-consuming, thereby decreasing the efficiency of controlling the brazing process. Accordingly, what are needed are improved methods and apparatuses for controlling a brazing process.

### SUMMARY

Embodiments of the invention provide a method and apparatus for controlling a brazing process. In one embodiment, the method includes receiving a signal from a tunable diode laser indicating a measured concentration of a gas present in an atmosphere in which the brazing process is performed. Responsive to the received signal, a control signal is issued to adjust at least one brazing process control setting affecting a change in subsequently measured concentrations of the gas present in the atmosphere.

One embodiment of the invention also provides an apparatus for controlling a brazing process. The apparatus includes a control system configured to receive a signal from a tunable diode laser indicating a measured concentration of a gas present in an atmosphere in which the brazing process is performed. The control system is further configured to, responsive to the received signal, issue a control signal to adjust at least one brazing process control setting affecting a change in subsequently measured concentrations of the gas present in the atmosphere.

Embodiments of the invention also provide an apparatus for performing a brazing process. In one embodiment, the apparatus includes a brazing chamber, a tunable diode laser, a detector, and a control system. The brazing chamber is formed within a housing and containing an atmosphere in which the brazing process is performed. The tunable diode laser is configured to emit a laser beam which passes through the atmosphere in which the brazing process is performed. The detector is configured to detect the laser beam after the laser beam has passed through the atmosphere in which the brazing process is performed. The control system is configured to receive a signal from the tunable diode laser via the detector indicating a measured concentration of a gas present in the atmosphere in which the brazing process is performed. Responsive to the received signal, the control system is configured to issue a control signal to adjust at least one brazing process control setting affecting a change in subsequently measured concentrations of the gas present in the atmosphere.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 illustrates an exemplary brazing process according to one embodiment of the invention;

FIG. 2 illustrates an exemplary tunable diode laser for use in the brazing process according to one embodiment of the invention;

FIG. 3 illustrates an exemplary process for controlling the brazing process according to one embodiment of the invention;

FIG. 4 illustrates an exemplary brazing process including multiple tunable diode lasers according to one embodiment of the invention;

FIG. 5 illustrates exemplary tunable diode lasers for controlling the brazing process according to one embodiment of the invention; and

FIG. 6 illustrates a tunable diode laser configuration for controlling the brazing process according to one embodiment of the invention.

### DESCRIPTION OF PREFERRED EMBODIMENTS

Embodiments of the invention generally provide methods and apparatuses for controlling a brazing process. In one embodiment, the method includes receiving a signal from a tunable diode laser indicating a measured concentration of a gas present in an atmosphere in which the brazing process is performed. Responsive to the received signal, a control signal is issued to adjust at least one brazing process control setting affecting a change in subsequently measured concentrations of the gas present in the atmosphere. In some cases, using the tunable diode laser may provide a fast and accurate measurement of contaminants within the brazing chamber. The measurement may then be used to provide improved control of process control variables (e.g., temperature, flux, and nitrogen flow) for the brazing process. For example, if measurements from the tunable diode laser indicate excess contaminants in the brazing process, then the flow of nitrogen from the nitrogen supply through one or more gas outlets into a brazing chamber for the brazing process may be increased.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable media. Illustrative computer-readable media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

### The Brazing Process

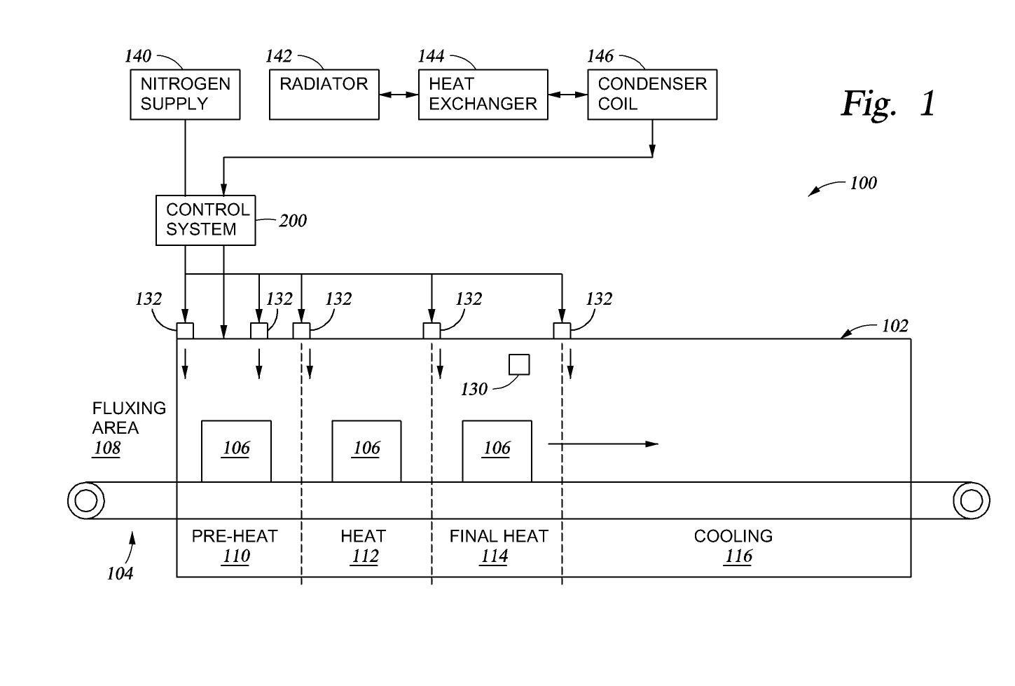

FIG. 1 is a block diagram depicting an exemplary brazing process 100 according to one embodiment of the invention. The brazing process 100 may be performed in part in a brazing chamber 102 formed within a brazing housing. Where the brazing process 100 is performed in part in the brazing chamber 102, the brazing process may be referred to as a controlled-atmosphere brazing process. While the brazing process 100 is being performed, a conveyor belt 104 may move components 106 being brazed through the brazing chamber 102 (referred to as continuous brazing). The brazing process 100 may include any brazing process known to those skilled in the art, such as the NOCOLOK™ brazing process which may be used for components 106 (e.g., heating, ventilation, and air conditioning, or HVAC, components) made of aluminum.

During the brazing process 100, the conveyor belt 104 may move the components 106 through different areas 108, 110, 112, 114, 116 of the brazing process 100. For example, flux may be applied to the components 106 in a fluxing area 108. The components may then be move through a pre-heat area 110, a heating area 112, a final heating area 114, and a cooling area 116. Each heating and cooling area 110, 112, 114, 116 may apply different temperatures to the components 106 to ensure a high-quality braze.

In one embodiment, the temperature within the brazing chamber 102 may be at least partially set using a heating system formed from a radiator 142, heat exchanger 144, and condenser coil 146. A nitrogen supply 140 may also be used to add nitrogen to the brazing chamber 102 via gas outlets 132 which may produce an inert atmosphere in which the brazing may be performed. The valves may add nitrogen to one or more areas 110, 112, 114, 116 of the brazing process 100 and may also be used to create “curtains” of inert gas between the brazing areas 108, 110, 112, 114, 116. The curtains of inert gas may act as buffers between the brazing areas 108, 110, 112, 114, 116 thereby preventing or reducing contaminants from a given stage of the brazing process 100 from moving to a subsequent stage of the brazing process 100.

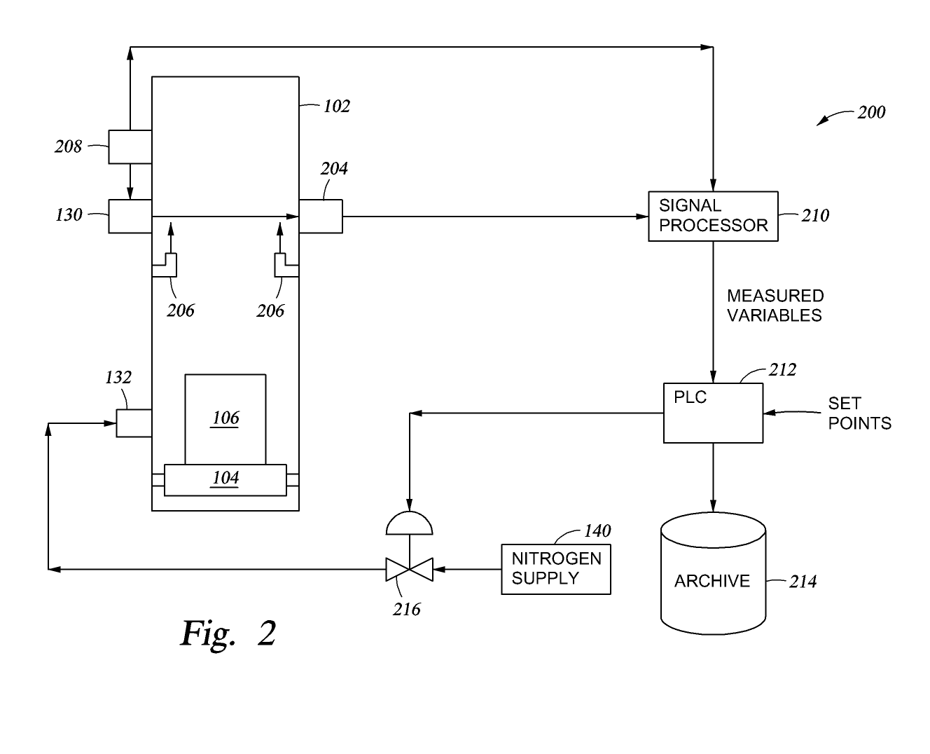

In one embodiment, a control system 200, described below with respect to FIG. 2, may be used to control the temperature and/or nitrogen flow in one or stages 108, 110, 112, 114, 116 of the brazing process 100. As described below, in one embodiment, a tunable diode laser (TDL) 130 may be used to measure the gasses within the brazing chamber 102 and improve control of the brazing process 100.

### Measuring the Brazing Chamber Atmosphere

As described above, during brazing, the components 106 being brazed may be heated to high temperatures in an atmosphere which includes nitrogen gas. The nitrogen gas may provide an atmosphere which is mostly inert. However, if the atmosphere in the brazing chamber 102 does not include enough nitrogen, contaminants such as oxygen and/or moisture may contaminate the areas of the components 106 being brazed, resulting in a weaker brazed joint. In some cases, to reduce such contamination, the components 106 may be covered with flux (e.g., in the fluxing area 108). When the components 106 are heated, the flux may melt and cover the area being brazed, reducing exposure to any contaminants in the brazing chamber 102. However, where the brazing chamber 102 does not include enough nitrogen, the flux may not sufficiently prevent contamination.

In one embodiment of the invention, the tunable diode laser 130 may be used to measure the concentration of gasses within the atmosphere of the brazing chamber 102 as depicted, for example, with respect to the control system 200 in FIG. 2. As described below, using the tunable diode laser 130 may provide a fast and accurate measurement of contaminants within the brazing chamber 102. The measurement may then be used to provide improved control of process control variables (e.g., temperature, flux, and nitrogen flow) for the brazing process 100. For example, if measurements from the tunable diode laser 130 indicate excess contaminants within the brazing chamber 102, then the flow of nitrogen from the nitrogen supply 140 through one or more gas outlets 132 into the brazing chamber 102 may be increased.

During measurement, a laser beam may be directed from a tunable diode laser source 130 across the brazing chamber 102 to a detector 204 which may detect the laser beam. As the laser beam is directed across the brazing chamber 102, gasses within the chamber 102 may interfere with the laser beam, producing an absorption spectrum which is detected by the detector 204. Thus, the signal detected by the detector 204 may be processed by a signal processor 210 to determine the concentration of contaminants within the brazing chamber 102.

In some cases, the concentration of contaminants (e.g., moisture and/or oxygen, as described above) may be measured directly from the absorption spectrum. Optionally, the spectrum may provide an indirect indication of the concentration of contaminants. For example, where the contaminants react with other chemicals during brazing to form a byproduct (e.g., as described below with respect to the reaction of fluoride vapors and moisture to produce hydrogen fluoride), the concentration of the contaminants may be determined by using the absorption spectrum to measure the concentration of the byproduct, from which the concentration of the contaminants may be measured. The signal processor 210 may also derive other variables which describe aspects of the brazing process, such as the dew point within the brazing chamber 102.

While described with respect to detecting a concentration of a gas (e.g., either by direct measurement or by indirect measurement of byproducts), in some cases, the tunable diode laser 130 may be used merely to detect the presence or absence of contaminants (e.g., whether any contaminants are present or not). As described herein, if contaminants are detected, then process control settings may be modified, for example, until the contaminants are not detected.

In one embodiment, before performing measurements with the tunable diode laser 130, the laser 130 may be calibrated, for example, to provide greater accuracy with respect to measuring certain chemicals in the atmosphere of the brazing chamber 102. In some cases, a temperature sensor 208 may be used to determine the temperature of the atmosphere within the brazing chamber 102. The temperature measurement may then be provided to the tunable diode laser 130 to calibrate the laser 130. In some cases, the measured temperature may also be provided to the signal processor 210 for use in controlling the brazing process 100. Furthermore, in one embodiment, temperature measurements and/or calibrations of the laser 130 using the temperature measurements may be performed continuously or at set intervals, thereby maintaining correct calibration of the laser 130.

After the signal processor 210 has received the signals from the tunable diode laser 130 and calculated values for the process variables, the measured variables may be provided to a controller (such as the programmable logic controller (PLC) 212) which may use the measured variables to control one or more aspects of the brazing process 100. For example, the measured variables may be compared to set points (e.g., desired values for the variables) to determine whether the brazing process 100 is being performed according to specifications.

If the comparison between the measured variables and the set points indicates that the process 100 is not being performed according to specifications, the PLC 212 may modify control settings for the process 100. For example, if the measured variables indicate the presence of excess contaminants within the brazing chamber 102, the PLC 212 may automatically increase the flow of nitrogen into the brazing chamber 102 by modifying a control setting for a control valve 216 which controls introduction of nitrogen into the brazing chamber 102 and thereby reducing (e.g., by displacement) the concentration of contaminants in the brazing chamber 102. The PLC 212 may also be used to control the temperature within the brazing chamber 102, for example, in response to a measured dew point within the brazing chamber 102. Because of the feedback provided by the tunable diode laser 130, signal processor 210, and PLC 212, the control system 200 depicted in FIG. 2 may be referred to as a closed loop control system (e.g., one which includes negative feedback derived comparing the measured variables and set points).

In one embodiment of the invention, the PLC 212 may be configured to automatically adjust control settings of the brazing process 100. For example, the PLC 212 may use PID (proportional-integrated and differential) control methods known to those skilled in the art to maintain control of the brazing process 100. The PLC 212 may also store data about the brazing process 100 (e.g., measured variables and control settings) in an archive 214 (e.g., a computer-readable medium such a disk drive which includes a database and/or in files in a file system).

The stored data in the archive 214 may be used to control the brazing process 100 and may also be used to study long-term trends of the brazing process 100. For example, a leak in the brazing chamber 102 may cause a sudden, continued increase in nitrogen usage. By monitoring the trend data, the sudden, continued increase in nitrogen usage may be detected and used to identify the leak in the brazing chamber 102. In some cases, the archive 214 may also be used to store processing and control programs for the signal processor 210 and PLC 212. Optionally, all or a portion of the control programs may be stored separately, for example, in a solid-state memory of the signal processor 210 and/or PLC 212.

In some cases, the atmosphere of the brazing chamber 102 may include corrosive chemicals which otherwise harm measurement equipment placed within the brazing chamber 102. For example, where potassium aluminum fluoride is used as flux, when the flux is melted during brazing, the flux may release fluoride vapors which may react with trace amounts of moisture in the atmosphere of the brazing chamber 102 to form corrosive hydrogen fluoride (HF). Where measurement equipment is placed within the brazing chamber 102, the hydrogen fluoride may corrode the equipment, thereby damaging the equipment and preventing its use.

In one embodiment, the tunable diode laser 130 may be used to obtain a measurement of the atmosphere within the brazing chamber 102 without placing the laser source 130 and/or detector 204 physically inside the brazing chamber 102 (e.g., by shining the laser beam through a first window of the chamber 102 and detecting the laser beam through a second window of the chamber 102). By placing the laser source 130 and/or detector 204 outside of the brazing chamber 102, the source 130 and/or detector 204 may be isolated from the corrosive atmosphere of the brazing chamber 102 which might otherwise harm the source 130 and/or detector 204.

In some cases, to prevent the laser source 130 and/or detector 204 from being obscured (e.g., covered with smoke or other byproducts of the brazing process 100), one or more purge 206 (e.g., a gas outlet positioned proximally to and/or aimed at an area of the brazing chamber 102) may be used to blow an inert gas (e.g., nitrogen from the nitrogen supply 140) over the areas through which the laser source 130 shines the laser beam and/or areas through which the detector 204 detects the laser beam. Thus, the purges 206 may prevent build-up of chemical byproducts of the brazing process over the source 130 and/or detector 204 which might otherwise be obscured.

It should be noted that the systems 100 and 200 described with respect to FIGS. 1 and 2, respectively, are merely illustrative and not limiting of the invention. Other embodiments, within the scope of the present invention, may include other configurations or types of devices and may perform a brazing in a different manner.

### Controlling the Brazing Process

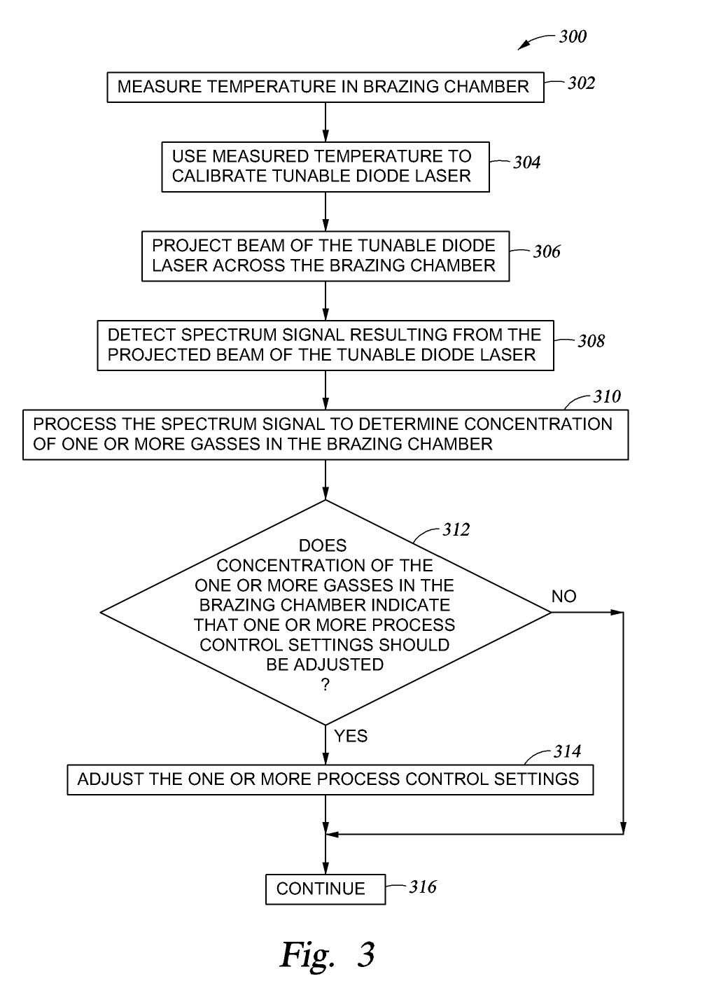

FIG. 3 is a flow diagram depicting a process 300 for controlling the brazing process 100 according to one embodiment of the invention. In one embodiment, the process 300 may be performed by the signal processor 210 and PLC 212 working in conjunction. Optionally, another configuration of processors or circuitry may be used. For example, in one embodiment, a single processor may be used for both signal processing and control. Separate circuitry may also be provided, for example, to automatically make measurements using the temperature sensor 208 and/or calibrate the tunable diode laser 130 using the temperature measurement.

The process 300 may begin at step 302 where the temperature in the brazing chamber 102 is measured, for example, using the temperature sensor 208. At step 304, the measured temperature may be used to calibrate the tunable diode laser 130. At step 306, a beam of the tunable diode laser 130 may be projected across the brazing chamber 102. Then, at step 308, a spectrum signal resulting from the projected beam of the tunable diode laser 130 may be detected, for example, using detector 204.

At step 310, the spectrum signal may be processed, for example, using signal processor 210, to determine the concentration of one or more gasses in the brazing chamber 102 (e.g., oxygen, moisture, hydrogen fluoride, etc.). At step 312, a determination may be made of whether the concentration of the one or more gasses in the brazing chamber 102 indicates that one or more process control settings (e.g., the flow of nitrogen, the temperature of one or more stages of the brazing process 100, etc.) should be adjusted. As described above, the determination may include a comparison of measured process variables to set points for the brazing process 100 to determine if the process 100 is being performed according to specification.

If a determination is made that the process 100 is not being performed according to specification, the one or more process control settings may be adjusted at step 314. For example, if the tunable diode laser measurements indicate that there are too many contaminants in the brazing chamber 102, the flow of nitrogen from the nitrogen source 140 through one or more of the outlets 132 may be increased. The flow may be changed, for example, by using the PLC 212 to modify a control valve setting for a control valve 216 which controls the flow of nitrogen from the nitrogen source 140. If the level of contaminants in the brazing chamber is sufficiently low, then the flow of nitrogen may be decreased.

The process 300 may continue at step 316. For example, the tunable diode laser 130 may be used to make multiple measurements, either constantly or at several intervals. Furthermore, calibration of the tunable diode laser 130 may be maintained, e.g., constantly, at fixed time intervals, after a predetermined number of measurements, or as otherwise desired.

As described above with respect to FIGS. 1-3, the tunable diode laser may provide fast, efficient measurements of the conditions within the brazing chamber 102. Because the measurements are made quickly and efficiently, control over the brazing process 100 may be improved, both by automating the control system 200 and by making the control system 200 more responsive to changes in the brazing process 100. Where the brazing process 100 changes over time, for example, due to operating conditions, during initial break-in of the brazing process 100, and as the brazing process 100 ages, the control system 200 may automatically correct changes in the brazing process 100, thereby improving the long-term efficiency of the process 100. Additional exemplary configurations for measurement and control of the brazing process 100 are also described below.

### Placement of the Tunable Diode Laser

In one embodiment of the invention, measurement of the atmosphere of the brazing chamber 102 may be performed in an area which is separate from the area being controlled by the PLC 212. For example, with respect to FIG. 1, a single tunable diode laser 130 may be used to measure in the atmosphere of the brazing chamber 102 in the final heat stage 114 of the brazing process 100, while the PLC 212 may be used to modify control of the nitrogen flow from the nitrogen supply 140 to the pre-heat stage 110 of the brazing chamber 102. Optionally, a single laser 130 may also be used to control aspects (such as the flow of nitrogen) in multiple stages 108, 110, 112, 114 of the brazing process 100.

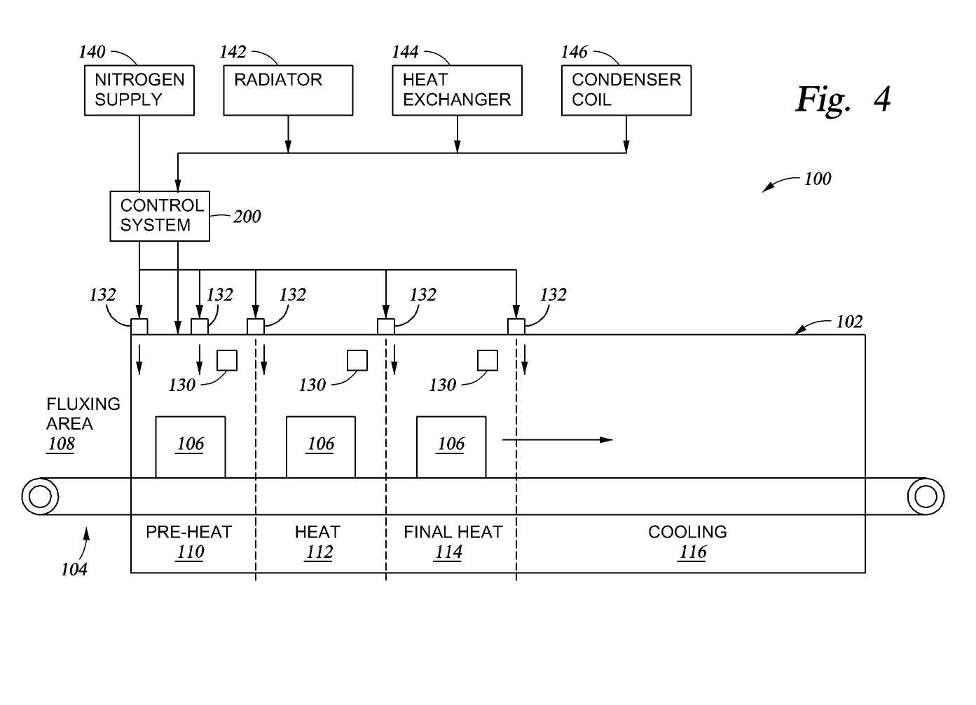

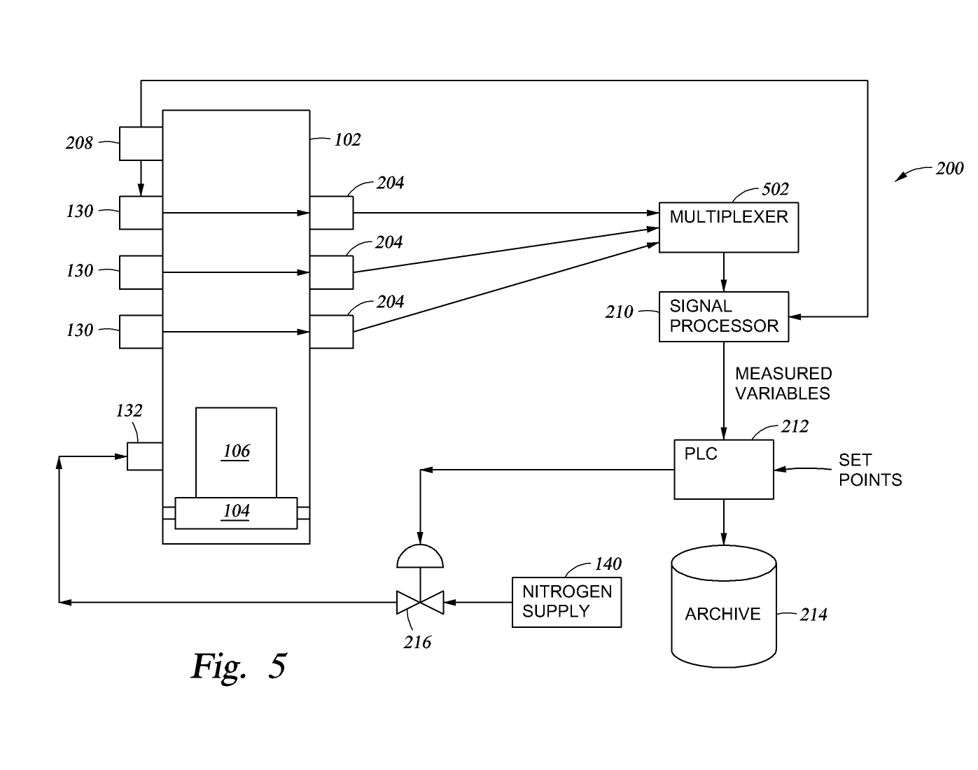

In some cases, multiple tunable diode lasers may also be used to measure the atmosphere in multiple stages (e.g., two or more of stages 108, 110, 112, 114, 116) of the brazing process 100 as depicted, for example, in FIG. 4. The multiple lasers 130 may each be calibrated, for example, with a single temperature sensor 208 as depicted in FIG. 5. Optionally, multiple temperature sensors 208 may be used to calibrate the lasers 130, for example, with one temperature sensor being provided to calibrate each of the lasers 130, respectively. Output from each of the tunable diode lasers 130 may be provided to a multiplexer 502 which provides data for each of the signals to the signal processor 210. The signal processor 210 may then analyze data from each of the tunable diode lasers 130 to determine the concentration of one or more gasses in each of the stages 110, 112, 114, 116 which include a tunable diode laser. The results of the analysis (e.g., the measured process variables) may then be provided from the signal processor 210 to the PLC 212. By using data from multiple tunable diode lasers 130 to measure the atmosphere in multiple stages 110, 112, 114, 116 of the brazing process 100, the PLC 212 may provide improved control for each stage 110, 112, 114, 116 of the brazing process 212.

In one embodiment of the invention, each of the tunable diode lasers 130 may be placed at a height or directed in such a manner that the path of the laser beam from a tunable diode laser 130 to a detector 204 does not cross into an area occupied by a component 106 being brazed. By directing the path of the laser beam so that it is not obscured by the components 106, measurements of the atmosphere within the brazing chamber 102 may be performed as components 106 are being brazed at a given location. Optionally, the tunable diode laser 130 may be positioned in such a manner that the path of the laser beam is occasionally obscured by components 106 (e.g., as the components 106 move down the conveyor belt 114). In such a case, measurements with the tunable diode laser 130 may be performed intermittently, for example, such that measurements are performed between the moving components 106 when the path of the laser beam is not obscured.

In general, a given detector 204 may be positioned in any manner such that the detector 204 detects signals from one or more tunable diode lasers 130. As depicted, for example, with respect to FIG. 1, the detector 204 may be positioned directly opposite the tunable diode laser 130 in the brazing chamber 102. Optionally, the tunable diode laser 130 and detector 204 may be placed at an angle with respect to each other to direct the laser beam of the tunable diode laser 130 across a larger portion of the brazing chamber 102. In some cases, by directing the laser beam across a larger portion of the brazing chamber 102 (and thus through a larger volume of the gasses in the brazing chamber 102), a more accurate (e.g., more defined) absorption spectrum may be obtained via the detector 204, thereby improving the accuracy of the measured variables provided to the PLC 212, which may in turn result in more accurate control of the brazing process 102.

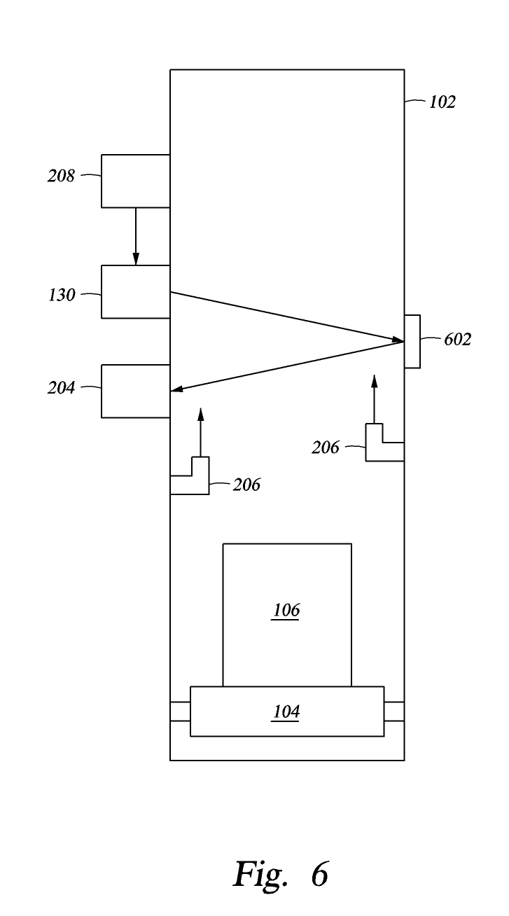

Furthermore, in one embodiment of the invention, the laser beam provided by the tunable diode laser 130 may be directed across an increased volume of the brazing chamber 102 by reflecting the laser beam off of one or more reflectors 602 (e.g., a mirror or other reflective surface) and into the detector 204 as depicted in FIG. 6. The tunable diode laser 130, detector 204, and/or the reflector 602 may be protected by one or more purges 206 which provide a buffer of inert gas (e.g., nitrogen) between the measurement instruments 130, 204, 602 and the corrosive atmosphere of the brazing chamber 102. By reflecting the laser beam from the tunable diode laser 130, the path of the laser beam between the laser source 130 and the detector 204 may, for example, be doubled. As described above, by increasing the path length of the laser beam, the absorption spectrum detected by the detector 204 may be improved, thereby resulting in improved control of the brazing process 100.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A method of controlling a brazing process, the method comprising:
receiving a signal from a tunable diode laser indicating a measured concentration of a gas present in an atmosphere in which the brazing process is performed; and
responsive to the received signal, issuing a control signal to adjust at least one brazing process control setting affecting a change in subsequently measured concentrations of the gas present in the atmosphere.

2. The method of claim 1, wherein the control signal adjusts the at least one brazing process control setting relative to a desired measured concentration.

3. The method of claim 1, wherein the at least one brazing process control setting is a control setting for an inert gas provided within a brazing chamber of the brazing process.

4. The method of claim 1, further comprising:
recording trend data indicating a trend of gas usage in the brazing process; and
analyzing the trend data to determine if the trend data indicates increased gas usage resulting from a leak in a brazing chamber of the brazing process.

5. The method of claim 1, further comprising:
recording trend data indicating a trend of nitrogen usage in the brazing process; and
analyzing the trend data to determine if the trend data indicates increased nitrogen usage resulting from a leak in a brazing chamber of the brazing process.

6. The method of claim 1, further comprising:
performing a temperature measurement of the atmosphere in which the brazing process is performed; and
in response to the temperature measurement, calibrating the tunable diode laser.

7. The method of claim 1, further comprising:
providing a purge outlet positioned to blow an inert gas over a surface through which a laser beam from the tunable diode laser is passed, thereby preventing the surface from being obscured.

8. The method of claim 1, further comprising:
providing a reflective surface opposite the tunable diode laser, wherein the reflective surface is positioned to reflect a laser beam emitted from the tunable diode laser into a detector which is used to detect the signal from the tunable diode laser.

9. The method of claim 8, wherein the tunable diode laser is positioned outside of a brazing chamber of the brazing process.

10. The method of claim 1, wherein the measured concentration of a gas is measured in a final heat stage of the brazing process.

11. The method of claim 1, wherein the measured concentration is used to determine one of a hydrogen fluoride concentration and a dew point for the brazing process.

12. The method of claim 1, wherein the control signal adjusts a brazing process control setting for one of an amount of flux applied to a component being brazed, a temperature for at least a portion of the brazing process, and a flow of gas for the brazing process.

13. An apparatus for controlling a brazing process, the apparatus comprising:
a control system configured to:
receive a signal from a tunable diode laser indicating a measured concentration of a gas present in an atmosphere in which the brazing process is performed; and
responsive to the received signal, issue a control signal to adjust at least one brazing process control setting affecting a change in subsequently measured concentrations of the gas present in the atmosphere.

14. The apparatus of claim 13, wherein the control signal adjusts the at least one brazing process control setting relative to a desired measured concentration.

15. The apparatus of claim 13, wherein the at least one brazing process control setting is a control setting for an inert gas provided within a brazing chamber of the brazing process.

16. The apparatus of claim 13, wherein the control system is further configured to:
record trend data indicating a trend of gas usage in the brazing process; and
analyze the trend data to determine if the trend data indicates increased gas usage resulting from a leak in a brazing chamber of the brazing process.

17. The apparatus of claim 13, wherein the control system is further configured to:
record trend data indicating a trend of nitrogen usage in the brazing process; and
analyze the trend data to determine if the trend data indicates increased nitrogen usage resulting from a leak in a brazing chamber of the brazing process.

18. The apparatus of claim 13, wherein the control system is further configured to:
perform a temperature measurement of the atmosphere in which the brazing process is performed; and
in response to the temperature measurement, calibrate the tunable diode laser.

19. The apparatus of claim 13, wherein the measured concentration is used to determine one of a hydrogen fluoride concentration and a dew point for the brazing process.

20. The apparatus of claim 13, wherein the control signal adjusts a brazing process control setting for one of an amount of flux applied to a component being brazed, a temperature for at least a portion of the brazing process, and a flow of gas for the brazing process.

21. An apparatus for performing a brazing process, the apparatus comprising:
a brazing chamber formed within a housing and containing an atmosphere in which the brazing process is performed;
a tunable diode laser configured to emit a laser beam which passes through the atmosphere in which the brazing process is performed;
a detector configured to detect the laser beam after the laser beam has passed through the atmosphere in which the brazing process is performed;
a control system configured to:
receive a signal from the tunable diode laser via the detector indicating a measured concentration of a gas present in the atmosphere in which the brazing process is performed; and
responsive to the received signal, issue a control signal to adjust at least one brazing process control setting affecting a change in subsequently measured concentrations of the gas present in the atmosphere.

22. The apparatus of claim 21, wherein the control signal adjusts the at least one brazing process control setting relative to a desired measured concentration.

23. The apparatus of claim 21, wherein the at least one brazing process control setting is a control setting for an inert gas provided within the brazing chamber.

24. The apparatus of claim 21, wherein the control system is further configured to:
record trend data indicating a trend of gas usage in the brazing process; and
analyze the trend data to determine if the trend data indicates increased gas usage resulting from a leak in a brazing chamber of the brazing process.

25. The apparatus of claim 21, wherein the control system is further configured to:
record trend data indicating a trend of nitrogen usage in the brazing process; and
analyze the trend data to determine if the trend data indicates increased nitrogen usage resulting from a leak in a brazing chamber of the brazing process.

26. The apparatus of claim 21, wherein the control system is further configured to:
perform a temperature measurement of the atmosphere in which the brazing process is performed; and
in response to the temperature measurement, calibrate the tunable diode laser.

27. The apparatus of claim 21, further comprising:
a purge outlet positioned to blow an inert gas over a surface through which a laser beam from the tunable diode laser is passed, thereby preventing the surface from being obscured.

28. The apparatus of claim 21, further comprising:
a reflective surface opposite the tunable diode laser, wherein the reflective surface is positioned to reflect a laser beam emitted from the tunable diode laser into a detector which is used to detect the signal from the tunable diode laser.

29. The apparatus of claim 28, wherein the tunable diode laser is positioned outside of the brazing chamber.

30. The apparatus of claim 21, wherein the measured concentration of a gas is measured in a final heat stage of the brazing process.

31. The apparatus of claim 21, wherein the measured concentration is used to determine one of a hydrogen fluoride concentration and a dew point for the brazing process.

32. The apparatus of claim 21, wherein the control signal adjusts a brazing process control setting for one of an amount of flux applied to a component being brazed, a temperature for at least a portion of the brazing process, and a flow of gas for the brazing process.
